(19) United States
(12) Patent Application Publication
(10) Pub. No.: US 2023/0237386 A1
(43) Pub. Date: Jul. 27, 2023

(54) FORECASTING TIME-SERIES DATA USING ENSEMBLE LEARNING

(71) Applicant: WORKDAY, INC., Pleasanton, CA (US)

(72) Inventors: Madhura RAUT, San Francisco, CA (US); David BOSWORTH, Phoenix, AZ (US)

(21) Appl. No.: 17/584,749

(22) Filed: Jan. 26, 2022

(51) Int. Cl. G06N 20/20; G06K 9/62

(52) U.S. Cl. CPC G06N 20/20; G06K 9/6257

(57) ABSTRACT

The disclosure relates to predicting the future value of a time series. In an embodiment, a method is disclosed which includes generating a feature vector, the feature vector comprising a set of raw features and a plurality of lag features, the plurality of lag features including a current value of a selected feature in the set of raw features and one or more historical values of the selected feature; inputting the feature vector into a plurality of base models, the plurality of base models outputting a plurality of predictions, each prediction in the plurality of predictions representing future values of the selected feature; and predicting a future value of the selected feature by inputting the plurality of predictions into a meta-model.

### BACKGROUND

The example embodiments are directed towards machine learning and, in particular, predicting future time series data using an ensemble model.

Predicting time-series data is frequently a challenge in machine learning applications. For example, most techniques are limited to predicting the future value of a single feature and, in some cases, for a single future time period. As such, most techniques are unable to predict using multiple variables and across more than a single time period, which limits the application of the predictions in downstream applications.

### BRIEF DESCRIPTION OF THE DRAWINGS

FIG. 1 is a block diagram illustrating a system for predicting a future time series value using an ensemble model according to some of the example embodiments.

FIG. 2 is a block diagram illustrating a neural network used in a system for predicting a future time series value using an ensemble model according to some of the example embodiments.

FIG. 3 is a flow diagram illustrating a method for training an ensemble model for predicting a future time series value according to some of the example embodiments.

FIG. 4 is a flow diagram illustrating a method for using an ensemble model to predict a future time series value according to some of the example embodiments.

FIG. 5 is a flow diagram illustrating a method for using a predicted future time series value according to some of the example embodiments.

FIG. 6 is a flow diagram illustrating a method for generating examples for use with an ensemble model for predicting a future time series value according to some of the example embodiments.

FIG. 7 is a block diagram of a computing device according to some embodiments of the disclosure.

### DETAILED DESCRIPTION

The example embodiments describe a feature engineering pipeline and ensemble to train an ensemble model for predicting future time-series data. The example embodiments further describe such a model to predict such data and implement a demand prediction algorithm based on the predicted data.

In an embodiment, a feature engineering pipeline transforms raw data into feature vectors. The pipeline can remove outliers and interpolate missing data to clean data before data augmentation. During data augmentation, the example embodiments can use a combination of date-based augmentation, historical data augmentation, aggregating augmentation, and lag augmentation to generate intrinsic features. Further, in some embodiments, the example embodiments can use external data to augment raw data. For example, the example embodiments can use holiday or weather data to augment raw data. The example embodiments can apply the above feature engineering pipeline to both training data and prediction data to generate training and prediction examples, respectively.

During training, the example embodiments can retain a holdout period of a raw dataset and use data from the holdout period as label data. The example embodiments can then label the features using data from the holdout period to generate labeled training examples. The example embodiments utilize a predictive model, a neural network, and a meta-model. In some embodiments, the predictive model can include a decision tree-based model such as a random forest, Light Gradient Boosting Machine (LightGBM), eXtreme Gradient Boosting (XGBoost), etc. In some embodiments, the neural network can include a recurrent neural network (RNN) such as a long short-term memory (LSTM) network. Both the predictive model and neural network can generate respective predictions. The meta-model can use these predictions (and other features) to generate a final prediction in some embodiments. In some embodiments, the meta-model can fit a linear regression model to weigh the predictive model and neural network predictions.

In the embodiments, a method is disclosed that includes generating a feature vector, the feature vector comprising a set of raw features and a plurality of lag features, the plurality of lag features including a current value of a selected feature in the set of raw features and one or more historical values of the selected feature; inputting the feature vector into a plurality of base models, the plurality of base models outputting a plurality of predictions, each prediction in the plurality of predictions representing future values of the selected feature; and predicting a future value of the selected feature by inputting the plurality of predictions into a meta-model.

In some embodiments, generating the feature vector further includes generating an intrinsically augmented feature, the intrinsically augmented feature comprising one or more of a synthetic date feature, a historical feature, and an aggregate feature.

In some embodiments, generating the feature vector further includes generating an externally augmented feature, the externally augmented feature comprising one or more of a weather feature and an event feature.

In some embodiments, inputting the feature vector into a plurality of base models includes inputting the feature vector into a predictive model and inputting the feature vector into a neural network. In some embodiments, inputting the feature vector into a predictive model includes inputting the feature vector into a decision tree-based model. In some embodiments, inputting the feature vector into a decision tree-based model includes inputting the feature vector into a LightGBM model. In some embodiments, inputting the feature vector into a neural network includes inputting the feature vector into a recurrent neural network. In some embodiments, inputting the feature vector into a recurrent neural network includes inputting the feature vector into a long-short term memory network. In some embodiments, inputting the feature vector into a long-short term memory network includes generating a first prediction of the selected feature by inserting the plurality of lag features into the long-short term memory network; combining the first prediction with the feature vector to generate a concatenated vector; and generating a second prediction of the selected feature by inserting the concatenated vector into one or more dense layers.

In other embodiments, devices, systems, and non-transitory computer-readable media are described for performing these and other methods.

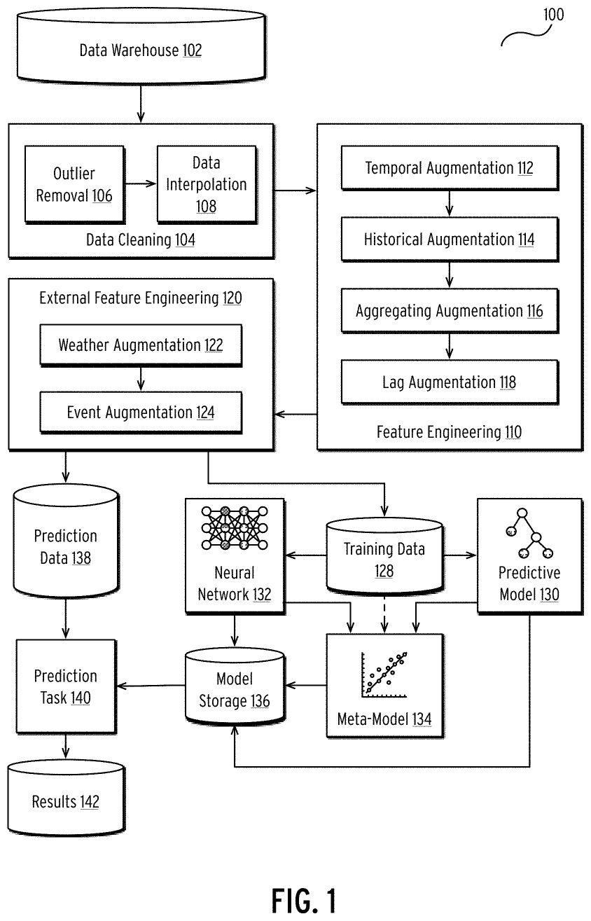

FIG. 1 is a block diagram illustrating a system 100 for predicting a future time series value using an ensemble model according to some of the example embodiments.

In an embodiment, a system 100 includes a data warehouse 102, data cleaning phase 104, feature engineering phase 110, external feature engineering phase 120, training data storage 128, predictive model 130, neural network 132, meta-model 134, and model storage 136. In an embodiment, the system 100 further includes prediction data storage 138, a prediction task 140, and results storage 142.

In an embodiment, data warehouse 102 can comprise one or more data storage devices for storing raw data. As used herein, raw data can refer to any data generated by a computing system during operations. As such, no limitation is placed on the format or type of data stored in data warehouse 102, and certain examples of data are likewise non-limiting.

As one example, raw data of a customer stored in data warehouse 102 can include records, each record associated with a time period based on a set granularity (e.g., half-hourly, hourly, daily, etc.), each record having a date, location (e.g., store) identifier, and context-specific data for the respective date. Context-specific data may vary depending on the underlying customer. For example, a retail customer's context-specific data can include a sales amount and number of transactions; a healthcare customer's context-specific data can include an expected number of patients; a fitness customer's context-specific data can include a number of membership card swipes; and a university's context-specific data can include the number of students on campus. Other data may be in each record, such as the size of a location (e.g., store), promotion or sales data (e.g., whether a sale is active, the discounts for a sale, etc.), store-specific holidays/events, etc.

Data warehouse 102 can be implemented in various forms such as a relational database, big data storage platform, or flat files. In the illustrated embodiment, data warehouse 102 can provide an interface to allow data cleaning phase 104 to retrieve data. In some embodiments, this interface can comprise an ad hoc query interface. In other embodiments, the interface can comprise a filesystem interface.

In an embodiment, data cleaning phase 104 can ingest data from data warehouse 102. Data ingested from data warehouse 102 to data cleaning phase 104 is referred to as raw data. In some embodiments, data cleaning phase 104 ingests data for training, while in other embodiments, data cleaning phase 104 ingests data for predicting. When ingesting data for training, data cleaning phase 104 can load a subset of all data stored in data warehouse 102 (e.g., the most recent three years). When ingesting data for predicting, data cleaning phase 104 can load a most recent subset of data (e.g., the most recent month). In some embodiments, data cleaning phase 104 can be implemented in software on shared computing hardware (e.g., virtual machines, containers, etc.). In other embodiments, data cleaning phase 104 can be implemented in hardware or a combination of hardware and software. While FIG. 1 illustrates that data interpolation process 108 executes after outlier removal process 106, the order may be reversed or may include additional steps, and no limit is placed on the ordering of processing.

Data cleaning phase 104 includes various processes, including an outlier removal process 106 and a data interpolation process 108. Other processes can be implemented. In general, data cleaning phase 104 analyzes all raw data and removes extraneous data or adds missing data. In an embodiment, outlier removal process 106 can analyze trends of the raw data to identify data points that are outliers relative to the raw data. For example, outlier removal process 106 can identify data points whose variance exceeds a threshold when compared to all similar data points. In an embodiment, data interpolation process 108 can conversely add new data points to the raw data. For example, some raw data may include missing field values (e.g., dates, locations) due to human error. When possible, data interpolation process 108 can synthesize these missing fields to complete the raw data. For example, a record may be missing a date but may also appear in a sequence of records all having the same date may be augmented with the date shared among the sequence of records. Raw data processed by data cleaning phase 104 is referred to as cleaned data.

A feature engineering phase 110 receives cleaned data from data cleaning phase 104. As illustrated, feature engineering phase 110 can include a plurality of processes that augment the cleaned data based on intrinsic data. As used herein, intrinsic data refers to data in the cleaned data itself or in other data in data warehouse 102. In the illustrated embodiment, feature engineering phase 110 includes a temporal augmentation process 112, a historical augmentation process 114, an aggregating augmentation process 116, and a lag augmentation process 118. More or fewer processes may be implemented as part of feature engineering phase 110. Further, the illustrated processes may implement some or all of the functions described herein or may perform additional functions. In some embodiments, feature engineering phase 110 can be implemented in software on shared computing hardware (e.g., virtual machines, containers, etc.). In other embodiments, feature engineering phase 110 can be implemented in hardware or a combination of hardware and software. While FIG. 1 illustrates that an ordering of the various processes of feature engineering phase 110, the order may be reversed, may include additional steps, or can be re-ordered, and no limit is placed on the ordering of processing.

In an embodiment, a temporal augmentation process 112 analyzes date fields and generates synthetic date features. For example, given a date in the cleaned data (e.g., in a YYYY-MM-DD format), temporal augmentation process 112 can generate features such as a day of the week feature (e.g., an integer between one and seven), a Boolean feature indicating whether the date is a Saturday or Sunday, an independent month number, an independent day number, an independent year number, or a week of the year number. In some embodiments, if the cleaned data includes a timestamp, temporal augmentation process 112 can extract an hour number (using a 24-hour clock). In some embodiments, temporal augmentation process 112 can further add an annotation indicating whether a given data is associated with a holiday in the jurisdiction of the location of the record.

In an embodiment, historical augmentation process 114 can analyze previous records based on a date or time of a record in the cleaned data and synthesize a past version of some or all features of the record. For example, a given record can include a sales volume. In such a scenario, historical augmentation process 114 can load the previous week's aggregate sales volume, the previous month's aggregate sales volume, the previous quarter's aggregate sales volume, and/or the previous year's aggregate sales volume. In some embodiments, an aggregate volume can comprise a summation of all relevant data. In some embodiments, historical augmentation process 114 can access this data from data warehouse 102 by using a store or location identifier associated with a record and querying the data warehouse 102 for historical records.

In an embodiment, aggregating augmentation process 116 can compute aggregates of historical data such as means or medians. Continuing the example of sales data, aggregating augmentation process 116 can compute a mean sales volume for the previous day, week, month, quarter, and/or year. In some embodiments, the means computed by aggregating augmentation process 116 can comprise rolling means. In some embodiments, aggregating augmentation process 116 can comprise calculating an exponentially weighted mean for each feature to aggregate. Alternatively, or in conjunction with the foregoing, aggregating augmentation process 116 can use the minimum, maximum, or standard deviation of measurements as features.

In an embodiment, lag augmentation process 118 can compute lag features for past time periods based on a record for a current time period. As discussed above, in some embodiments, the cleaned data (and raw data) is associated with a reporting granularity (e.g., half-hourly). Thus, each record is associated with a current time period t. As used herein, a lag feature refers to a current and one or more past versions of a value of a corresponding feature represented, for example, using a sliding-window approach. Thus, as an example, a sales volume captured at time t can be associated with sales volumes captured at times t−1, t−2, . . . t−n (e.g., a half-hour before t, one hour before t, etc.) and all values can be considered lag features. In some embodiments, lag augmentation process 118 can build these values based on data stored in data warehouse 102. For example, lag augmentation process 118 can load all historical records based on a store or location identifier of the current record and extract the then-current sales volumes as the lag features. The value of n can be referred to as the window size of the lag features. The value of n is not limiting, and various values can be used during tuning of neural network 132.

In an embodiment, various other intrinsic augmentations can be performed in feature engineering phase 110. In an embodiment, the augmentations in feature engineering phase 110 can be performed in parallel or in a different order than that illustrated. After an augmentation feature is generated, feature engineering phase 110 can add (e.g., concatenate) each augmentation feature to the cleaned data received from data cleaning phase 104. The augmented data generated in feature engineering phase 110 is referred to as intrinsically augmented data.

In an embodiment, external feature engineering phase 120 receives the intrinsically augmented data from feature engineering phase 110 and performs further augmentation using external data sources. As used herein, an external data source other than data warehouse 102 can be used to augment the intrinsically augmented data. As illustrated, external feature engineering phase 120 can include a weather augmentation process 122. In some embodiments, the weather augmentation process 122 can use a date and location in the intrinsically augmented data and identify a type of weather associated with the date and location. In some embodiments, the type of weather can comprise an enumerated type of weather condition (e.g., rain, snow, sun, etc.), a temperature, or similar types of measurements (or combinations thereof). As another example, external feature engineering phase 120 can include an event augmentation process 124. In an embodiment, the event augmentation process 124 can add data regarding events occurring on the date of the record and near the location in the record. In some embodiments, a third-party data source can provide data regarding various events (e.g., sports events, concerts, expositions, conferences, etc.) based on a date and location. In some embodiments, the event augmentation can be represented as a categorical enumeration of types of known events.

Although only weather augmentation process 122 and event augmentation process 124 are illustrated in external feature engineering phase 120, other event augmentations may be considered. For example, current oil or gasoline prices can be augmented based on the date and location. As another example, a level of engagement on social media (e.g., number of followers, recent posts, interactions) can be used as an external feature. In some embodiments, past event data can be used to generate augmented features. For example, a series of rainy days followed by a sunny day can be represented as a separate weather category (since such a day without rain may see an increase in sales volume versus a day in a sequence of sunny days). As another example, a ranking of a customer by a neutral ranking entity can be used to augment data. As another example, a foot traffic volume can be predicted using external data and used as augmentation data. As another example, active promotions (e.g., sales, coupons, special offers, seasonal additions, special events, etc.) can be used as augmentation data. As another example, general economic indicators of a region or country can be used as augmentation data. Intrinsically augmented data further augmented with external data is referred to as fully augmented data.

In an embodiment, external feature engineering phase 120 can store fully augmented data in training data storage 128 or prediction data storage 138. In some embodiments, a selected field in the fully augmented data can be used as a training label. For example, a sales volume field in the fully augmented data can be assigned as the label for a given example. Other fields can be used as labels. The fully augmented data with assigned labels is referred to as training data when written to the training data storage 128 for model training (described herein).

In contrast, when used for predicting a label, external feature engineering phase 120 can write all of the fully augmented data to training data storage 128. In some embodiments, the fully augmented data may only comprise a most recent time period of data.

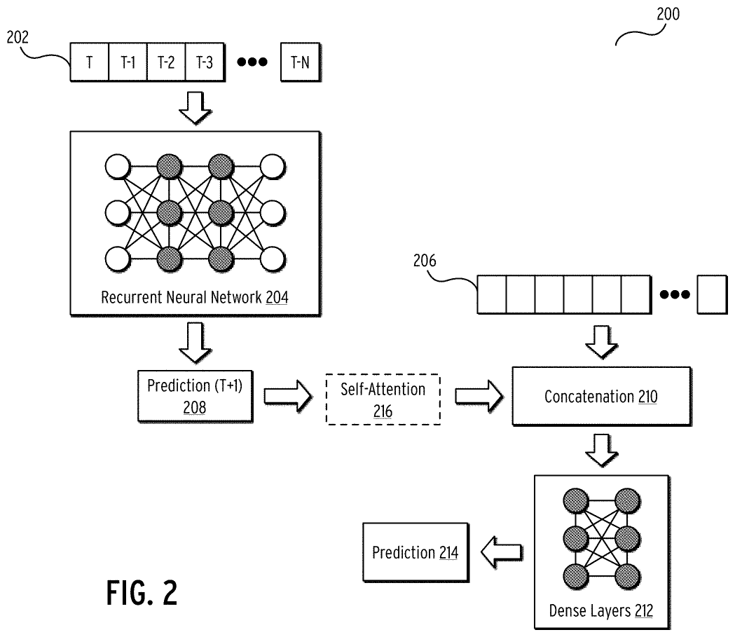

In an embodiment, neural network 132 can comprise a deep learning network such as that depicted in FIG. 2. As one example, neural network 132 can comprise a recurrent neural network (RNN) such as a long short-term memory (LS™) network. In some embodiments, the neural network 132 can include an LS™-based network for analyzing recent lag augmentations generated by lag augmentation process 118. For example, given the current time t the LS™-based network layers can predict the value at the next time in the sequence (t+1) based on lag features such as the value at the current time t, as well as the two prior times t−1 and t−2 as input variables. The predicted value can then be combined with the other features (both from raw data and augmented data) and used as input to one or more fully connected layers (i.e., hidden layers). The output of the hidden layers can be used by an output layer (e.g., activation layer) to generate a prediction of a future value of a target variable (e.g., sales volume). Various activation layers (e.g., sigmoid, rectified linear unit, etc.) may be used, and the disclosure is not limited as such. In some embodiments, during training data can be segmented into a holdout set (containing a known sales value for time tₕ for each example) and a training set (containing all examples having a time t<tₕ). In such a scenario, the holdout data can be used to measure the prediction error using a cost function. In some embodiments, this cost function can comprise a mean absolute error (MAE) function, Mean Absolute Percentage Error (MAPE), root-mean-squared error (RMSE) function, or similar cost function. Based on the cost computed using the cost function, the neural network 132 can employ backpropagation to adjust the weights of neurons in the network and retrain until the cost function outputs an error rate below a desired threshold. In some embodiments, a validation phase can then be used to tune hyperparameters of the network.

In an embodiment, training data is also fed to predictive model 130. In some embodiments, predictive model 130 can include a decision tree-based model such as a random forest, XGBoost, or a similar type of model. In an embodiment, predictive model 130 can comprise a gradient-boosting model such as LightGBM. In general, gradient boosting refers to a class of ensemble machine learning algorithms that can be used for classification or regression predictive modeling problems. Gradient-boosted models are fit using any arbitrary differentiable loss function and gradient descent optimization algorithm. This gives the technique its name, “gradient boosting,” as the loss gradient is minimized as the model is fit, much like a neural network. LightGBM extends the gradient boosting algorithm by adding a type of automatic feature selection as well as focusing on boosting examples with larger gradients. This can result in a dramatic speedup of training and improved predictive performance. Since LightGBM is based on decision tree algorithms, it splits the tree leaf-wise with the best fit, whereas other boosting algorithms split the tree depth-wise or level-wise rather than leaf-wise. So, when growing on the same leaf in LightGBM, the leaf-wise algorithm can reduce more loss than the level-wise algorithm and hence results in much better accuracy, which can rarely be achieved by any of the existing boosting algorithms.

In some embodiments, the predictive model 130 can be trained using training data having a format similar to that of neural network 132. However, in some embodiments, the predictive model 130 does not require segmentation of lag features as a separate stage, and examples having all augmented data can be fed into the predictive model 130. In some embodiments, a cost function can be used to train the network, such as an MAE, RMSE, Huber loss, etc.

Although only two models (predictive model 130 and neural network 132) are illustrated, additional models of varying types can be used. As such, the disclosure should not be read as being limited to only two models.

As illustrated, the outputs of predictive model 130 and neural network 132 are fed into meta-model 134. In some embodiments, meta-model 134 can comprise a linear regression model or similar regression model. In some embodiments, meta-model 134 weighs the predictions of predictive model 130 and neural network 132 to generate a blended, or ensemble, prediction according to: pₘₑₜₐ=ωₚpₚ+ωₙₑᵤᵣₐₗpₙₑᵤᵣₐₗ, where ωₚ represents a weight determined for the predictive model 130, pₚ represents a prediction of the predictive model 130, ωₙₑᵤᵣₐₗ represents a weight determined for the neural network 132, pₙₑᵤᵣₐₗ represents a prediction of the neural network 132, and pₘₑₜₐ represents the ensemble prediction of meta-model 134. More generally, pₘₑₜₐ can be represented as:

$${\sum }_{i = 1}^{n} {ω}_{n} {p}_{n} \qquad EQUATION 1$$

In Equation 1, ωₙ and pₙ represent the weight and prediction for an arbitrary predictive model or neural network i.

In some embodiments, meta-model 134 can receive, as inputs, any or all of the augmented data used to train predictive model 130 and neural network 132. In this embodiment, the features of the augmented data can be used to feature-weight the predictions of the predictive model 130 and neural network 132 using a feature-weighted linear stacking ensemble methodology.

In some embodiments, an MAE cost function can be used to tune the meta-model 134. In some embodiments, the MAE cost function can be defined as:

$$M A E = \frac{1}{n} {\sum }_{j = 1}^{n} \vert {y}_{j} - {\hat{y}}_{j} \vert \qquad EQUATION 2$$

In Equation 2, yⱼ represents a prediction of meta-model 134, ŷⱼ represents an expected result of a jth predictions, and n represents the total number of predictions made. In some embodiments, an MAE cost function can be used for all models (predictive model 130, neural network 132, and meta-model 134). As with other models, differing cost functions can be used. Like predictive model 130 and neural network 132, meta-model 134 can be tuned and validated until meeting a desired error rate.

After training, each of the models (predictive model 130, neural network 132, and meta-model 134) are stored in model storage 136. In some embodiments, model storage 136 can store the parameters of each of the models. In some embodiments, model storage 136 can comprise a relational database or other type of storage device. In some embodiments, model storage 136 can comprise a filesystem, and models can be stored as binary files. The specific type of data storage of model storage 136 is not limiting.

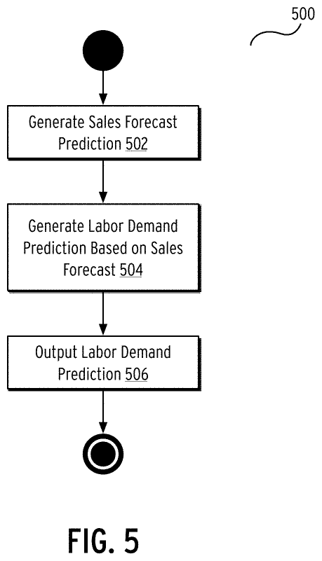

During prediction, a prediction task 140 can load a set of unlabeled examples from prediction data storage 138. The prediction task 140 can load each of the models (predictive model 130, neural network 132, and meta-model 134) and generate a prediction using the models. Specifically, the prediction task 140 can generate separate predictions from predictive model 130 and neural network 132 and feed these predictions (and optional features) into meta-model 134 for a final prediction. The prediction task 140 can then write the predictions to results storage 142 for downstream usage, as discussed in FIG. 5. In some embodiments, results storage 142 can comprise a file system, database, or memory device (e.g., random-access memory).

FIG. 2 is a block diagram illustrating a neural network 200 used in a system for predicting a future time series value using an ensemble model according to some of the example embodiments.

In the illustrated embodiment, a set of lag features 202 are received by the neural network 200. As discussed, the lag features 202 can include a set of current and historical features associated with a target variable. As used herein, a lag feature refers to a current and one or more past versions of a value of a corresponding feature represented, for example, using a sliding-window approach. Thus, as an example, a sales volume captured at time t can be associated with sales volumes captured at times t−1, t−2, . . . t−n (e.g., a half-hour before t, one hour before t, etc.) and all values can be considered lag features.

The lag features 202 are input into an RNN 204, such as a long short-term memory (LSTM) network. The RNN 204 can generate a prediction 208 of a future value (t+1) of the value associated with the lag features. For example, if the lag features 202 correspond to n sales volume measurements, the prediction 208 can comprise a prediction of the next time period's sales volume.

In an alternative embodiment, the output of RNN 204 can be input into a self-attention network 216 and the output of the self-attention network 216 can be output to the concatenation operation 210, in place of the RNN 204 output, as discussed below. In some embodiments, self-attention network 216 can comprise a multi-headed self-attention network. The self-attention network 216 can compute a weight vector that can weight the hidden state of all time steps processed by the self-attention network 216 (e.g., lag features) and can focus attention on the more important ones in the entire hidden state information sequence. The self-attention network 216 can thus rationally assign different weights to each part of the input data (e.g., lag features) to extract more credible and helpful information to make better predictions on the forecast data. In some embodiments, the weight vector can be used to select one or more lag feature values to forward to concatenation operation 210 for inclusion in downstream prediction. In some embodiments, the self-attention network 216 can be optional and included based on the desired performance goals. Specifically, the following error rates were observed with different configurations:

TABLE 1

| | | Single- | Multi- | Multi- |
|---|---|---|---|---|
| | | Head | Head Self- | Head Self- |
| | No Self- | Self- | Attention | Attention |
| | Attention | Attention | (2 heads) | (4 heads) |
| MAE | 8.87 | 8.32 | 7.75 | 7.89 |

Thus, as illustrated in Table 1, the inclusion of self-attention network 216 can decrease the error rate of the entire neural network 200.

The prediction 208 can then be added or concatenated with a set of augmented features 206 via concatenation operation 210. In some embodiments, the augmented features 206 can comprise the original augmented data output, for example, by external feature engineering phase 120. In some embodiments, concatenation operation 210 can add the prediction 208 to the end of the features or may insert the prediction 208 at any position in the augmented features 206.

The example output by augmented features 206 can then be input into a set of dense layers 212. In an embodiment, dense layers 212 can include one or more neural network layers that are fully connected. These dense layers can perform a matrix-vector multiplication. The values used in the matrix are parameters that can be trained and updated with the help of backpropagation. The output generated by the dense layer is an m dimensional vector. Dense layers 212 can also apply operations such as rotation, scaling, translation on the vector. In some embodiments, the output of the dense layers 212 can be used by an output layer (e.g., activation layer) to generate a prediction 214 of a future value of a target variable (e.g., sales volume). Various activation layers (e.g., sigmoid, rectified linear unit, etc.) may be used, and the disclosure is not limited as such.

Various details regarding training, validation, and prediction using neural network 200 were described in FIG. 1 and are not repeated herein.

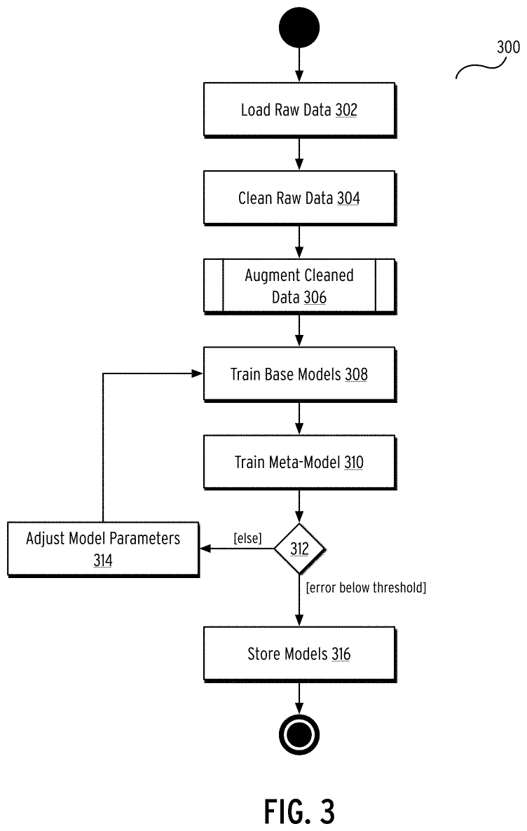

FIG. 3 is a flow diagram illustrating a method 300 for training an ensemble model for predicting a future time series value according to some of the example embodiments.

In step 302, method 300 can include loading raw data.

As used herein, raw data can refer to any data generated by a computing system during operations. As one example, raw data of a customer stored in a data warehouse (e.g., data warehouse 102) can include records, each record associated with a time period based on a set granularity (e.g., half-hourly, hourly, daily, etc.), each record having a date, location (e.g., store) identifier, and context-specific data for the respective date. Context-specific data may vary depending on the underlying customer. For example, a retail customer's context-specific data can include a sales amount and number of transactions; a healthcare customer's context-specific data can include an expected number of patients; a fitness customer's context-specific data can include a number of membership card swipes; and a university's context-specific data can include the number of students on campus. Other data may be in each record, such as the size of a location (e.g., store), promotion or sales data (e.g., whether a sale is active, the discounts for a sale, etc.), store-specific holidays/events, etc.

In step 304, method 300 can include cleaning the raw data to generate cleaned data.

In some embodiments, step 304 can include one or more of removing outliers and interpolating data. Other operations can be implemented. In general, step 304 can include analyzing all raw data and removing extraneous data or adding missing data. In an embodiment, method 300 can analyze trends of the raw data to identify data points that are outliers relative to the raw data. In an embodiment, method 300 can conversely add new data points to the raw data. When possible, method 300 can synthesize these missing fields to complete the raw data. In the various embodiments, record and example are used interchangeably and generally refer to a single set of data related to a single data point (e.g., a half-hour of data representing sales in a given store).

In step 306, method 300 can include augmenting the cleaned data.

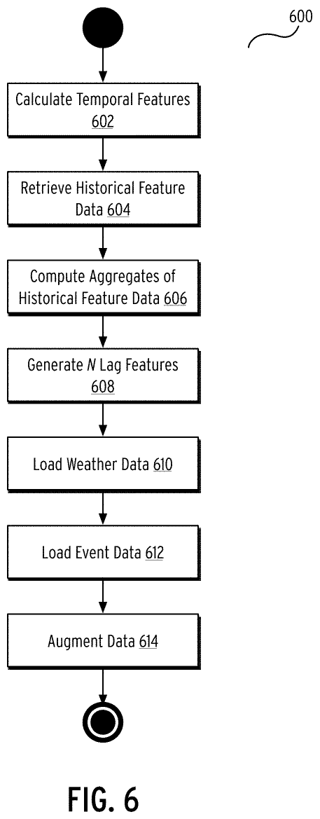

As used herein, augmenting refers to adding features to a cleaned example in the cleaned data. Details of step 306 are provided in FIG. 6 and are not repeated herein. In general, the augmented features include intrinsically augmented features (i.e., features generated based solely on local data) and externally augmented features (i.e., features provided by third parties). One example of an intrinsically augmented feature is a lag feature which refers to a past value of a given feature. The use of lag features allows for a window approach to time series representation suitable for downstream models. In some embodiments, a dimensionality reduction algorithm can be employed to reduce the total number of features based on their importance in training the base models or meta-modal.

In step 308, method 300 can include training a set of base models.

During training, the example embodiments can retain a holdout period of a raw dataset and use data from the holdout period as label data. The example embodiments can then label the features using data from the holdout period to generate labeled training examples.

In one embodiment, the base models can include a predictive model and a neural network. In an embodiment, the predictive model can include a decision tree-based model. In an embodiment, the tree-based model can include a LightGBM model. In an embodiment, the neural network can include an RNN. In an embodiment, the RNN can include an LSTM network. In an embodiment, the LSTM network can include an LSTM portion and a set of dense layers wherein the LSTM portion receives a lag feature and generates a first prediction, and the network combines the first prediction with the feature vector to generate a concatenated vector which is then inserted into one or more dense layers. The output of the dense layers can be used by an output layer (e.g., activation layer) to generate a prediction of a future value of a target variable (e.g., sales volume). Various activation layers (e.g., sigmoid, rectified linear unit, etc.) may be used, and the disclosure is not limited as such. In some embodiments, during training data can be segmented into a holdout set (containing a known sales value for time tₕ for each example) and a training set (containing all examples having a time t<tₕ). In such a scenario, the holdout data can be used to measure the prediction error using a cost function. In some embodiments, this cost function can comprise a mean absolute error (MAE) function, Mean Absolute Percentage Error (MAPE), root-mean-squared error (RMSE) function, or similar cost function. Based on the cost computed using the cost function, the neural network can employ back-propagation to adjust the weights of neurons in the network and retrain until the cost function outputs an error rate below a desired threshold. In some embodiments, a validation phase can then be used to tune hyperparameters of the network.

In some embodiments, the predictive model can be trained using training data having a format similar to that of a neural network. However, in some embodiments, the predictive model does not require segmentation of lag features as a separate stage, and examples having all augmented data can be fed into the predictive model. In some embodiments, a cost function can be used to train the network, such as an MAE, RMSE, Huber loss, etc.

Although only two models (predictive model and neural network) are illustrated, additional models of varying types can be used. As such, the disclosure should not be read as being limited to only two models.

In step 310, method 300 can include training a meta-model. In some embodiments, the meta-model can comprise a linear regression model or a similar regression model. In some embodiments, the meta-model weighs the predictions of the predictive model and the neural network to generate a blended, or ensemble, prediction according to: pₘₑₜₐ=ωₚpₚ+ωₙₑᵤᵣₐₗpₙₑᵤᵣₐₗ, where ωₚ represents a weight determined for the predictive model, pₚ represents a prediction of the predictive model, ωₙₑᵤᵣₐₗ represents a weight determined for the neural network, pₙₑᵤᵣₐₗ represents a prediction of the neural network, and pₘₑₜₐ represents the ensemble prediction of the meta-model. In some embodiments, the meta-model can receive, as inputs, any or all of the augmented data used to train the predictive model and neural network. In this embodiment, the features of the augmented data can be used to feature-weight the predictions of the predictive model and the neural network using a feature-weighted linear stacking ensemble methodology.

In some embodiments, an MAE cost function can be used to tune the meta-model. In some embodiments, an MAE cost function can be used for all models (predictive model, neural network, and meta-model). As with other models, differing cost functions can be used. Like the predictive model and neural network, the meta-model can be tuned and validated until meeting a desired error rate.

In step 312, method 300 can include determining if the prediction accuracy of the models meets a preconfigured accuracy threshold. As described above, each model can include a corresponding cost function that can be used to tune the models independently. In some embodiments, each model is tuned by comparing the output of the cost function to a preconfigured accuracy threshold.

In step 314, after method 300 determines that the prediction accuracy does not meet the preconfigured accuracy threshold, method 300 adjusts the model parameters and re-trains the model in step 308, step 310, and step 312. In some embodiments, method 300 can comprise independently tuning each model and then re-training the ensemble.

In step 316, once method 300 determines that the prediction accuracy meets the preconfigured accuracy threshold, method 300 stores the models. Once method 300 determines that the cost function of some of all models meets the preconfigured accuracy, method 300 can write the models to persistent storage. In some embodiments, the persistent storage can comprise a filesystem, and models can be stored as binary files. The specific type of data storage of the persistent storage is not limiting.

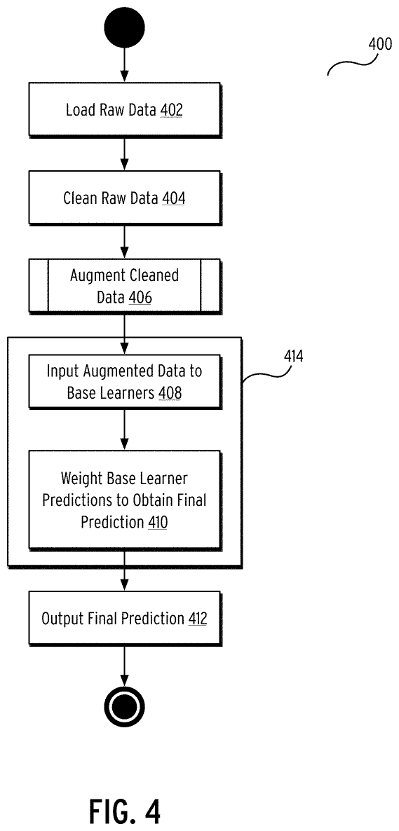

FIG. 4 is a flow diagram illustrating a method 400 for using an ensemble model to predict a future time series value according to some of the example embodiments.

In step 402, method 400 can include loading raw data. In step 404, method 400 can include cleaning raw data. In step 406, method 400 can include augmenting the cleaned data. Details of step 402, step 404, and step 406 are substantially similar to that of step 302, step 304, and step 306, respectively, and are not repeated herein. However, in step 402, method 400 may only load a most recent time period of data to use for prediction (versus an entire data set in step 302).

After cleaning and augmenting the raw data to generate examples, method 400 executes a prediction task procedure 414. As part of this procedure, method 400 can input the augmented data to base models in step 408 and then weight the predictions of the base learners to obtain a final prediction using a meta-model in step 410.

During prediction, prediction task procedure 414 can load a set of unlabeled examples generated in step 406. The prediction task procedure 414 can load each of the models (predictive model, neural network, and meta-model) trained using method 300 and generate a prediction using the models. Specifically, the prediction task procedure 414 can generate separate predictions from the predictive model and neural network and feed these predictions (and optional features) into a meta-model for a final prediction. As described above, in some embodiments, the meta-model can comprise a linear regression model or similar regression model and thus weights each model prediction according to a linear equation such as pₘₑₜₐ=ωₚpₚ ωₙₑᵤᵣₐₗpₙₑᵤᵣₐₗ, where ωₚ represents a weight determined for the predictive model, pₚ represents a prediction of the predictive model, ωₙₑᵤᵣₐₗ represents a weight determined for the neural network, pₙₑᵤᵣₐₗ represents a prediction of the neural network, and pₘₑₜₐ represents the ensemble prediction of the meta-model.

In step 412, method 400 can include outputting the final prediction. In some embodiments, method 400 can write the predictions to a storage device for downstream usage, as discussed in FIG. 5. In some embodiments, the results storage can comprise a file system, database, or memory device (e.g., random-access memory).

FIG. 5 is a flow diagram illustrating a method 500 for using a predicted future time series value according to some of the example embodiments.

In step 502, method 500 can include generating a sales forecast prediction. In an embodiment, step 502 can include loading a most recent time period (e.g., last half-hour, last day, etc.) and generating a prediction using this data using, for example, method 400. In some embodiments, a feature of “sales volume” can be used as the target (predictor). In some embodiments, step 502 can be repeated for multiple time periods (e.g., each half-hour of a workday).

In step 504, method 500 can include generating a labor demand prediction based on the sales forecast predicted in step 502. As used herein, a labor demand prediction refers to a predicted number of staff for a given store or location based on the underlying predicted sales forecast.

In an embodiment, a labor demand prediction can be made using a series of constraints or rules. For example, for each target variable, a set of ranges can be used to map predicted target variables to staffing requirements. Thus, for example, the sales volume of $0—$499.99 can be associated with a single manager, a sales volume of $500.00—$999.99 can be associated with two managers, etc. The following rules can be associated with each type of employee. Thus, in some embodiments, the sales forecast can be used to identify the appropriate range of the various rules, and then the corresponding labor requirements can be used as the predicted requirements.

In some embodiments, method 500 can be executed for multiple target features. Then, method 500 can include a step of weighting the various predicted labor demands. For example, method 500 can be executed to predict a sales volume and can be executed to predict a number of customer swipes (e.g., for a gym). Method 500 can then include weighting the labor requirements for each feature. the following Tables 1 and 2 are used as example constraints for differing target features (Sales and Swipes):

TABLE 2

| Sales | Managers |
|---|---|
| $0.00-$499.99 | 1 |
| $500.00-$999.99 | 2 |
| $1,000.00-$4,999.99 | 3 |

TABLE 3

| Swipes | Managers |
|---|---|
| 0-500 | 2 |
| 500-1,000 | 2 |
| 1,000-1,500 | 4 |

In this example, sales may be weighted 70%, while swipes may be weighted at 30%. Using these two tables, if method 500 predicts a sales volume of $749.91 and a swipe count of 1,234, method 500 can compute a predicted number of managers as 0.7·2+0.3 4=2.6, which may be rounded to three managers.

In step 506, method 500 can include outputting the labor predictions. In some embodiments, method 500 can include displaying the predicted labor demands via a user interface. In some embodiments, the prediction can comprise a daily prediction which can then be supplied to a constraint solver to determine the number of managers for smaller granularity time periods.

Further details on generating a labor prediction based on a time-series prediction are described in more detail in commonly-owned application having Attorney Docket No. 166310-800300, which is incorporated herein in its entirety.

FIG. 6 is a flow diagram illustrating a method 600 for generating examples for use with an ensemble model for predicting a future time series value according to some of the example embodiments.

In step 602, method 600 can include computing temporal features.

In an embodiment, method 600 can analyze date fields and generate synthetic date features. For example, given a date in the cleaned data (e.g., in a YYYY-MM-DD format), method 600 can generate features such as a day of the week feature (e.g., an integer between one and seven), a Boolean feature indicating whether the date is a Saturday or Sunday, an independent month number, an independent day number, an independent year number, or a week of the year number. In some embodiments, if the cleaned data includes a timestamp, method 600 can extract an hour number (using a 24-hour clock). In some embodiments, method 600 can further add an annotation indicating whether a given data is associated with a holiday in the jurisdiction of the location of the record.

In step 604, method 600 can include retrieving historical feature data.

In some embodiments, method 500 can access a repository of historical data for a given unique record (e.g., based on a store identifier and/or location). In general, the historical data will have a similar or identical format to the record being augmented.

In an embodiment, method 600 can analyze previous records based on a date or time of a record in the cleaned data and synthesize past versions of some or all features of the record. For example, a given record can include a sales volume. In such a scenario, method 600 can load the previous week's aggregate sales volume, the previous month's aggregate sales volume, the previous quarter's aggregate sales volume, and/or the previous year's aggregate sales volume. In some embodiments, an aggregate volume can comprise a summation of all relevant data. In some embodiments, method 600 can access this data from a data warehouse by using a store or location identifier associated with a record and querying the data warehouse for historical records.

In step 606, method 600 can include computing aggregates of historical data.

In an embodiment, method 600 can compute aggregates of historical data such as means or medians. Continuing the example of sales data, method 600 can compute a mean sales volume for the previous day, week, month, quarter, and/or year. In some embodiments, the means computed by method 600 can comprise rolling means. In some embodiments, method 600 can comprise calculating an exponentially weighted mean for each feature to aggregate. Alternatively, or in conjunction with the foregoing, method 600 can use the minimum, maximum, or standard deviation of measurements as features.

In step 608, method 600 can include generating n lag features.

In an embodiment, method 600 can compute lag features for past time periods based on a record for a current time period. As discussed above, in some embodiments, the cleaned data (and raw data) is associated with a reporting granularity (e.g., half-hourly). Thus, each record is associated with a current time period t. As used herein, a lag feature refers to a current and one or more past versions of a value of a corresponding feature represented, for example, using a sliding-window approach. Thus, as an example, a sales volume captured at time t can be associated with sales volumes captured at times t−1, t−2, . . . t−n (e.g., a half-hour before t, one hour before t, etc.) and all values can be considered lag features. In some embodiments, method 600 can build these values based on data stored in a data warehouse. For example, method 600 can load all historical records based on a store or location identifier of the current record and extract the then-current sales volumes as the lag features. The value of n can be referred to as the window size of the lag features. The value of n is not limiting and various values can be used during tuning of a neural network.

In step 610, method 600 can include loading weather data.

In some embodiments, method 600 can use a date and location in the intrinsically augmented data and identify a type of weather associated with the date and location. In some embodiments, the type of weather can comprise an enumerated type of weather condition (e.g., rain, snow, sun, etc.), a temperature, or similar types of measurements (or combinations thereof).

In step 612, method 600 can include loading event data.

As another example, method 600 can add data regarding events occurring on the date of the record and near the location in the record. In some embodiments, a third-party data source, such as that provided by PredictHQ Ltd. of Auckland, New Zealand, can provide data regarding various events (e.g., sports events, concerts, expositions, conferences, etc.) based on a date and location. In some embodiments, the event augmentation can be represented as a categorical enumeration of types of known events.

In an embodiment, various other augmentations can be performed by method 600. For example, current oil or gasoline prices can be augmented based on the date and location. As another example, a level of engagement on social media (e.g., a number of followers, recent posts, interactions) can be used as an external feature. In some embodiments, past event data can be used to generate augmented features. For example, a series of rainy days followed by a sunny day can be represented as a separate weather category (since such a day without rain may see an increase in sales volume versus a day in a sequence of sunny days). As another example, a ranking of a customer by a neutral ranking entity can be used to augment data. As another example, a foot traffic volume can be predicted using external data and used as augmentation data. As another example, active promotions (e.g., sales, coupons, special offers, seasonal additions, special events, etc.) can be used as augmentation data. As another example, general economic indicators of a region or country can be used as augmentation data. Intrinsically augmented data further augmented with external data is referred to as fully augmented data. In an embodiment, the augmentations in method 600 can be performed in parallel or in a different order than that illustrated.

In step 614, method 600 can include augmenting the original data with the data generated in step 602 through step 612. For example, in some embodiments, method 600 can concatenate all of the features generated in step 602 through step 612 to the original data.

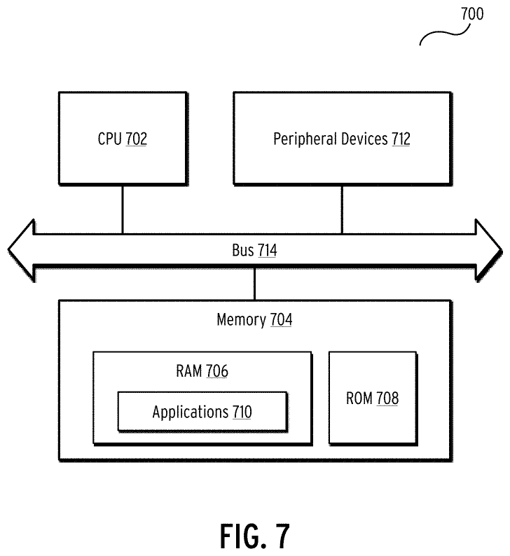

FIG. 7 is a block diagram of a computing device 700 according to some embodiments of the disclosure. In some embodiments, the computing device can be used to train and use the various ML models described previously.

As illustrated, the device includes a processor or central processing unit (CPU) such as CPU 702 in communication with a memory 704 via a bus 714. The device also includes one or more input/output (I/O) or peripheral devices 712. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 702 may comprise a general-purpose CPU. The CPU 702 may comprise a single-core or multiple-core CPU. The CPU 702 may comprise a system-on-a-chip (SoC) or a similar embedded system. In some embodiments, a graphics processing unit (GPU) may be used in place of, or in combination with, a CPU 702. Memory 704 may comprise a non-transitory memory system including a dynamic random-access memory (DRAM), static random-access memory (SRAM), Flash (e.g., NAND Flash), or combinations thereof. In one embodiment, the bus 714 may comprise a Peripheral Component Interconnect Express (PCIe) bus. In some embodiments, bus 714 may comprise multiple busses instead of a single bus.

Memory 704 illustrates an example of non-transitory computer storage media for the storage of information such as computer-readable instructions, data structures, program modules, or other data. Memory 704 can store a basic input/output system (BIOS) in read-only memory (ROM), such as ROM 708, for controlling the low-level operation of the device. The memory can also store an operating system in random-access memory (RAM) for controlling the operation of the device

Applications 710 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 706 by CPU 702. CPU 702 may then read the software or data from RAM 706, process them, and store them in RAM 706 again.

The device may optionally communicate with a base station (not shown) or directly with another computing device. One or more network interfaces in peripheral devices 712 are sometimes referred to as a transceiver, transceiving device, or network interface card (NIC).

An audio interface in peripheral devices 712 produces and receives audio signals such as the sound of a human voice. For example, an audio interface may be coupled to a speaker and microphone (not shown) to enable telecommunication with others or generate an audio acknowledgment for some action. Displays in peripheral devices 712 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 712 may comprise any input device arranged to receive input from a user. An illuminator in peripheral devices 712 may provide a status indication or provide light. The device can also comprise an input/output interface in peripheral devices 712 for communication with external devices, using communication technologies, such as USB, infrared, Bluetooth™, or the like. A haptic interface in peripheral devices 712 provides tactile feedback to a user of the client device.

A GPS receiver in peripheral devices 712 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 7, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
generating a feature vector, the feature vector comprising a set of raw features and a plurality of lag features, the plurality of lag features including a current value of a selected feature in the set of raw features and one or more historical values of the selected feature;
inputting the feature vector into a plurality of base models, the plurality of base models outputting a plurality of predictions, each prediction in the plurality of predictions representing future values of the selected feature; and
predicting a future value of the selected feature by inputting the plurality of predictions into a meta-model.

2. The method of claim 1, wherein generating the feature vector further comprises generating an intrinsically augmented feature, the intrinsically augmented feature comprising one or more of a synthetic date feature, a historical feature, and an aggregate feature.

3. The method of claim 1, wherein generating the feature vector further comprises generating an externally augmented feature, the externally augmented feature comprising one or more of a weather feature and an event feature.

4. The method of claim 1, wherein inputting the feature vector into the plurality of base models comprises inputting the feature vector into a predictive model and inputting the feature vector into a neural network.

5. The method of claim 4, wherein inputting the feature vector into the predictive model comprises inputting the feature vector into a decision tree-based model.

6. The method of claim 5, wherein inputting the feature vector into the decision tree-based model comprises inputting the feature vector into a LightGBM model.

7. The method of claim 4, wherein inputting the feature vector into the plurality of base models further comprising inputting the output of the neural network into a self-attention network and using an output of the self-attention network as a prediction in the plurality of predictions.

8. The method of claim 4, wherein inputting the feature vector into the neural network comprises inputting the feature vector into a recurrent neural network.

9. The method of claim 7, wherein inputting the feature vector into the recurrent neural network comprises inputting the feature vector into a long-short term memory network.

10. The method of claim 8, wherein inputting the feature vector into the long-short term memory network comprises:
generating a first prediction of the selected feature by inserting the plurality of lag features into the long-short term memory network;
combining the first prediction with the feature vector to generate a concatenated vector; and
generating a second prediction of the selected feature by inserting the concatenated vector into one or more dense layers.

11. A non-transitory computer-readable storage medium for tangibly storing computer program instructions capable for execution by a computer processor, the computer program instructions defining steps of:
generating a feature vector, the feature vector comprising a set of raw features and a plurality of lag features, the plurality of lag features including a current value of a selected feature in the set of raw features and one or more historical values of the selected feature;
inputting the feature vector into a plurality of base models, the plurality of base models outputting a plurality of predictions, each prediction in the plurality of predictions representing future values of the selected feature; and
predicting a future value of the selected feature by inputting the plurality of predictions into a meta-model.

12. The non-transitory computer-readable storage medium of claim 11, wherein generating the feature vector further comprises generating an intrinsically augmented feature, the intrinsically augmented feature comprising one or more of a synthetic date feature, a historical feature, and an aggregate feature.

13. The non-transitory computer-readable storage medium of claim 11, wherein generating the feature vector further comprises generating an externally augmented feature, the externally augmented feature comprising one or more of a weather feature and an event feature.

14. The non-transitory computer-readable storage medium of claim 11, wherein inputting the feature vector into the plurality of base models comprises inputting the feature vector into a predictive model and inputting the feature vector into a neural network.

15. The non-transitory computer-readable storage medium of claim 14, wherein inputting the feature vector into the predictive model comprises inputting the feature vector into a decision tree-based model.

16. The non-transitory computer-readable storage medium of claim 14, wherein inputting the feature vector into the neural network comprises inputting the feature vector into a recurrent neural network.

17. The non-transitory computer-readable storage medium of claim 16, wherein inputting the feature vector into the recurrent neural network comprises:
generating a first prediction of the selected feature by inserting the plurality of lag features into a long-short term memory network;
combining the first prediction with the feature vector to generate a concatenated vector; and
generating a second prediction of the selected feature by inserting the concatenated vector into one or more dense layers.

18. A system comprising:
a processor configured to:
generate a feature vector, the feature vector comprising a set of raw features and a plurality of lag features, the plurality of lag features including a current value of a selected feature in the set of raw features and one or more historical values of the selected feature;
input the feature vector into a plurality of base models, the plurality of base models outputting a plurality of predictions, each prediction in the plurality of predictions representing future values of the selected feature; and
predict a future value of the selected feature by inputting the plurality of predictions into a meta-model.

19. The system of claim 18, wherein inputting the feature vector into the plurality of base models comprises:
inputting the feature vector into a predictive model; and
inputting the feature vector into a neural network.

20. The system of claim 19, wherein inputting the feature vector into the predictive model comprises inputting the feature vector into a decision tree-based model and wherein inputting the feature vector into the neural network comprises inputting the feature vector into a recurrent neural network.
